(19) United States
(12) Patent Application Publication
(10) Pub. No.: US 2002/0065929 A1
(43) Pub. Date: May 30, 2002

(54) Protocol extensions to increase reliability of bulk data transmissions

(75) Inventors: Lee Kamentsky, Arlington, MA (US); John LaCroix, Williston, VT (US); Chaitanya Kanojia, Newton, MA (US); Peter Hall, Ashtead Surrey (GB)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Navic Systems Inc., Newton, MA

(21) Appl. No.: 10/004,223

(22) Filed: Nov. 2, 2001

Related U.S. Application Data
(60) Provisional application No. 60/253,337, filed on Nov. 28, 2000.

(51) Int. Cl. G06F 15/16

(52) U.S. Cl. 709/231

(57) ABSTRACT

A multimedia network involves sending an initial schedule message prior to broadcast or multicast of a content file. The content file could be a promotion or other file that must be efficiently sent to a large number of end node devices, such as television set top boxes. The schedule message contains at least a bulk transfer end time for the content file so that the end node devices are aware of when the later bulk data transmission of the content file should be completed. The schedule message may contain other parameters such as promotion identification, message start time, duration, frequency, multicast address and port number. The bulk message containing the promotion is then sent using an efficient bulk transfer messaging technique, such as a multicast Universal Data Protocol (UDP) message which does not require acknowledgment of individual packets or individual addresses of the end node devices to be maintained. At the expected end of the transmission time, a determination is made as to whether or not the expect bulk message has been received. If not, the network device reports a message failure to the original scheduling process, which in turn retransmits the promotion package to the previously failing network device via a reliable transport protocol, such as TCP.

### RELATED APPLICATION(S)

This application claims the benefit of U.S. Provisional Application No. 60/253,337, filed on Nov. 28, 2000, the teachings of which are incorporated herein by reference.

### BACKGROUND OF THE INVENTION

At the present time, most data network devices located in residences include some type of personal computer. Typically, these personal computers are used to connect to Internet Service Providers over dial-up connections to execute application programs such as email clients and Web browsers that utilize the global Internet to access text and graphic content. Increasingly, the demand is for multimedia content, including audio and video, to be delivered over such networks. However, the backbone architectures of purely data networks, especially those designed for use with the telephone network, were not originally designed to handle such high data rates.

The trend is towards a more ubiquitous model where the network devices in the home will be embedded systems designed for a particular function or purpose. This has already occurred to some degree. Today, for example, cable television (CATV) network set-top boxes typically have limited data communication capabilities. The main function of the data devices is to handle channel access between residential users and a head end or server on the cable TV network.

It is estimated that the worldwide market for Internet appliances such as digital set-top boxes and Web-connected terminals will reach $17.8 billion in 2004, and millions of such digital set-top boxes have already been deployed. Increasingly, advertisers and content providers view the cable set-top as the first platform of choice for widespread delivery of a suite of intelligent content management and distribution services.

In the future, the functionality offered by these set-top boxes or other embedded platforms, such as game systems, will be expanded. For example, they may offer Internet browsing capabilities and e-commerce serving capabilities. Moreover, it is anticipated that common-household appliances will also have network functionality, in which they will be attached to the network to automate various tasks.

### SUMMARY OF THE INVENTION

In brief overview, the process involves (1) scheduling transmissions of promotion packages for delivery to a specific promotion group; (2) notifying network devices in the promotion group of the scheduled bulk data transmission(s), including and an expected start and duration; (3) transmitting the packages of promotions via multicast or broadcast using an efficient mechanism such as UDP datagrams which do not require individual acknowledgments to be returned; (4) selectively receiving a subset of the promotions during the scheduled transmissions, and at the network devices; (5) at the expected end of the bulk transmission, determining if the expected bulk data has been received; (6) if not, requesting a unicast transmission from the bulk server using a more reliable mechanism; (7) if that fails, reporting a message failure to the original scheduling process, such as a promotion manager; and (8) retransmitting the promotion package to the failing network device via a more reliable mechanism from the promotion manager.

### BRIEF DESCRIPTION OF THE DRAWINGS

FIG. 1 is a block diagram of a multimedia content broadcast system such as a cable television network which uses a reliable bulk message delivery technique according to the invention.

FIG. 2 is a more detailed view of a bulk message package containing a number of multimedia promotions.

FIGS. 3A, 3B, and 3C illustrate a database table maintained for the promotion package.

FIG. 4A is a UDP remote moniker forming part of a message sent to a bulk agent, which describes how the bulk agent is to listen for bulk data.

FIG. 4B is a bulk server UDP scheduler message which informs the bulk server of how and when to transmit bulk messages.

FIG. 5 is a process flow diagram for a reliable bulk message transfer process according to one embodiment of the invention.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF A PREFERRED EMBODIMENT

1. A Targeted Promotion Delivery System

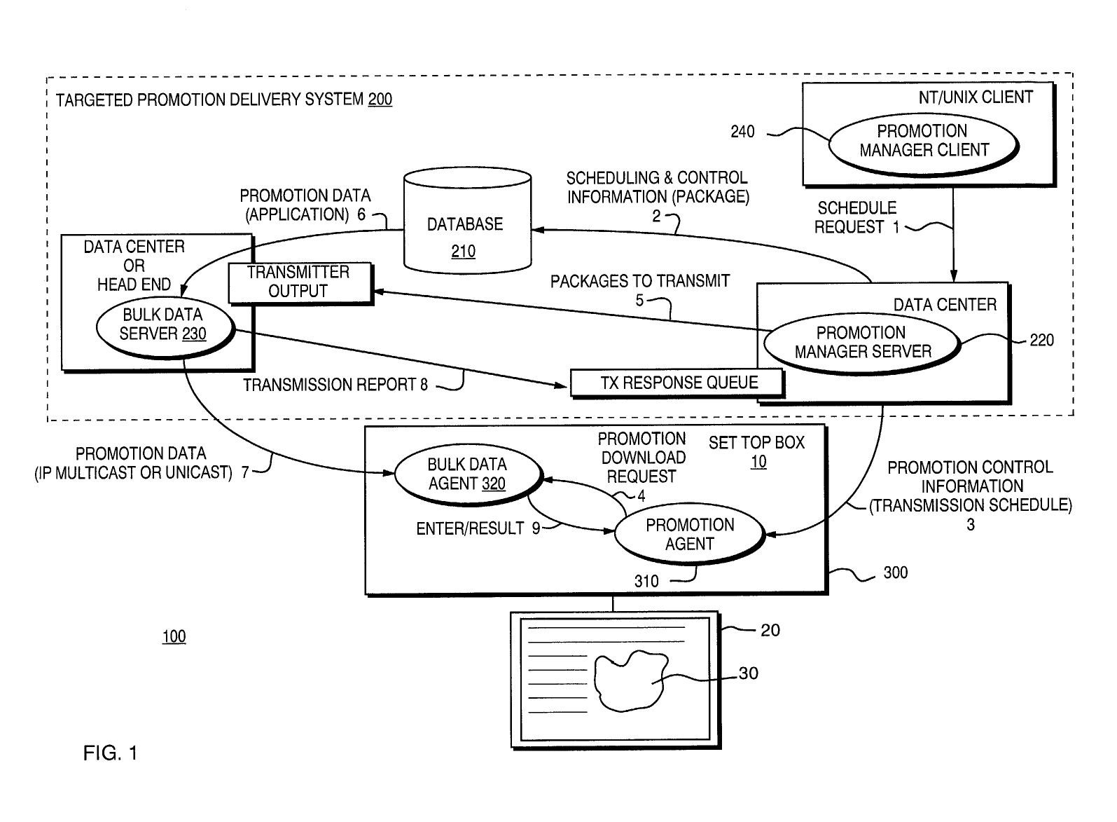

Turning attention now to the drawings, FIG. 1 illustrates a multimedia content delivery system 100 according to one embodiment of the present invention. The system includes a large number of set top boxes or network devices 10 connected to respective video displays 20, such as televisions. Promotions 30 typically include promotional content that may be presented in various multimedia formats including standard audio visual clips, but also computer graphics, icons, or Internet hyperlinks. Promotions are used to advertise goods and services, promote events, or present other commercial or non-commercial information. One or more promotions 30 may be simultaneously active within the video displays 20 and may be displayed in different ways. For example, promotions 30 can be presented on electronic program guides, channel information bars, or by overlaying video broadcast programming. Some active promotions that may be displayed on digital set top boxes allow user interaction such as linking to e-commerce web-sites via hyperlink connections or direct communication a promotion delivery system to obtain additional software, such as device drivers, video games, or other application software.

As shown in FIG. 1, the system also includes a promotion server subsystem 200 located at a data center, and a promotion agent subsystem 300 embedded within each of the network devices. The promotion server subsystem 200 and the promotion agent subsystems 300 communicate with each other through a combination of application-level messaging and serialized bulk data transmissions.

The promotion server subsystem 200 periodically collects viewer usage data from the promotion agent subsystem 300 of each of the multimedia content viewing devices to generate viewership profiles. In television networks, the data collected by the promotion server subsystem 200 may include tuner data (i.e., a history of channels watched) and responses to past promotions. This history is kept on a relatively fine time scale, such as five seconds. In this way, it can be determined how long a particular promotion was deployed, or even which portions of a promotion or video program were viewed.

Regarding promotion delivery, the promotion server subsystem 200 includes a database server 210, a promotion manager server 220, a bulk data server 230, a promotion manager client 240. These components are typically located at a central location in the multimedia network at a data center, head end, or divided between the two depending on the density and population of devices.

To determine how to deliver targeted promotions to the network devices, the promotion server subsystem 200 generates viewership profiles for each of the multimedia content viewing devices from the collected data using a variety of statistical models. The viewership profiles are then used to associate groups of network devices with a given target promotion.

Promotion groups are collections of multimedia content viewing devices whose individual viewership profiles match membership criterion describing a particular demographic or viewership history. For example, a promotion group may be demographically based, i.e., “married women in their 30's with more than one school age child and a household income of at least $100,0000,” or based on viewership history, i.e., “tends to watch the Golf Channel on Sunday afternoon.” Therefore, the promotion server subsystem is adaptable to changes in viewer usage or viewership patterns by making adjustments to promotion groups. Promotion groups are described in more detail in the U.S. Provisional Patent Application Serial No. 60/253,488 filed Nov. 28, 2000, entitled “Using Viewership Profiles for Targeted Promotion Deployment” which is hereby incorporated by reference in its entirety.

Promotions are then scheduled for delivery to specific promotion groups. A promotion is scheduled for delivery to a promotion group by an advertiser or service provider entering a scheduling request for a promotion. As promotions are scheduled, the promotion manager server adds or removes promotion groups and/or scheduling information to promotions. This causes creation or modification of promotion packages via stored procedures in the database 210. Later, the package information is read from the database 210 and used to create customized transmission schedules that specify when and how each of the network devices 10 is to receive it.

The promotion agent subsystem 300 embedded in each of the network devices 10 includes a promotion agent 310 and a bulk data agent 320. Upon receipt of a transmission schedule message, the promotion agent 310 signals the bulk data agent 320 wait for each promotion identified in the transmission schedule. The bulk data agent 320 then handles the reception of the promotions from the scheduled data transmission as specified in the promotion download requests. For example, in one embodiment, the bulk data agent 320 tunes into a multicast data transmission stream at a specified time and channel or network address specified in the transmission schedule.

The promotion manager server 220 extracts the promotion package from the database 210 and converts it into a transmission request that is sent to the bulk data server 230. The bulk data server 230 fetches the promotions from the database 210 that are identified in the transmission request message, and transmits them via multicast or broadcast transmission depending on transmission control data specified in the transmission request.

Once the promotions have been successfully delivered, the promotions are activated at the network viewing devices as specified in promotion control data of the transmission schedules. Promotion activation may be event, time, or channel driven.

2. Promotion Packaging for Transmission Groups

Promotions may be scheduled for promotion groups that include diverse types of network devices 10. For example, a promotion group may include devices 10 that are functionally different, such as television set top boxes and Internet video phones. Even functionally similar types of devices (e.g., set top boxes) may differ with respect to certain physical and functional device attributes. Such attributes may include data storage capacity and the ability to receive multicast transmissions using standard data protocols, such as Transmission Control Protocol or Universal Data Protocol over Internet Protocol (TCP/IP or UDP/IP) networks. Device attributes have a direct effect on the manner in which promotions and other content are actually delivered to devices of targeted promotion groups. For example, devices with less data storage capacity are not able to cache as many promotions as devices with more storage capacity. The promotion delivery system adapts the delivery of promotions to the attributes of different device types within a promotion group through the use of packages.

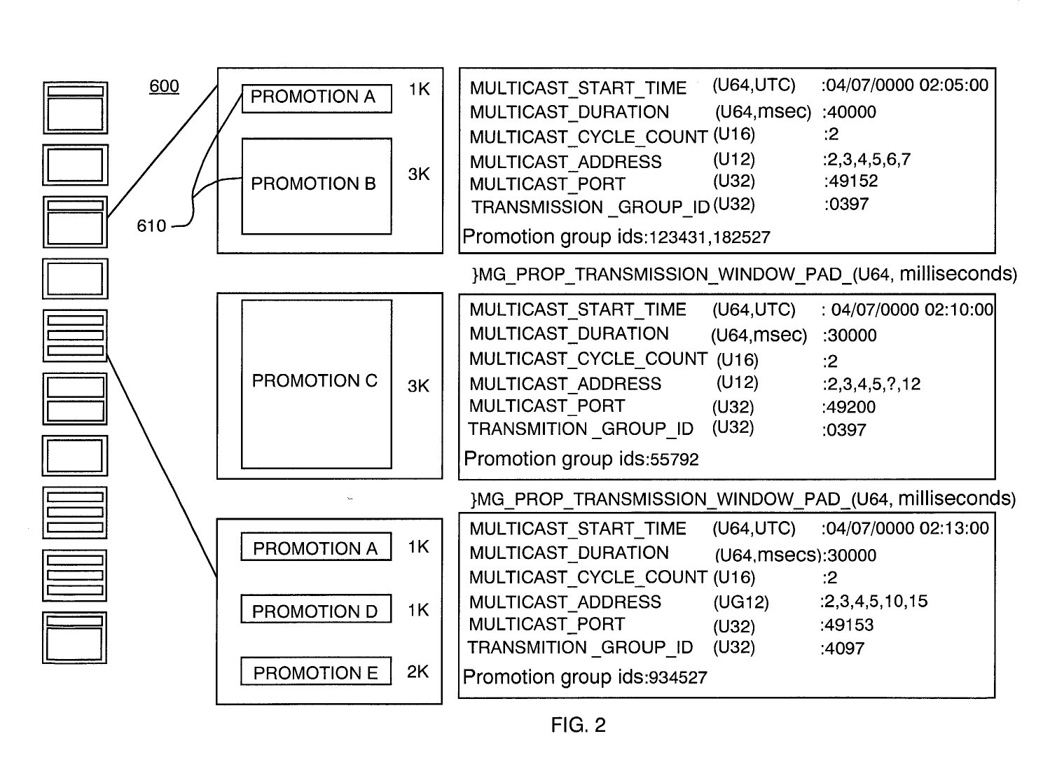

FIG. 2 is a diagram illustrating a set of packages according to one embodiment. A package is a data object 600 containing a set of promotions 610 and data transmission parameters 620 that specify the manner of delivery of a set of promotions to a specific transmission group. Transmission groups are sets of network devices 10 sharing common device attributes, such as storage and resource limitations. For example, set top boxes of a particular model number may be considered to be part of the same transmission group.

Promotion packages are then created for each transmission group which adapt the data transmission parameters 620 of the particular package in a manner which optimizes the corresponding device attributes. Promotion packages are created or modified by the promotion manager server 220 and stored in the database 210 automatically as promotions are scheduled.

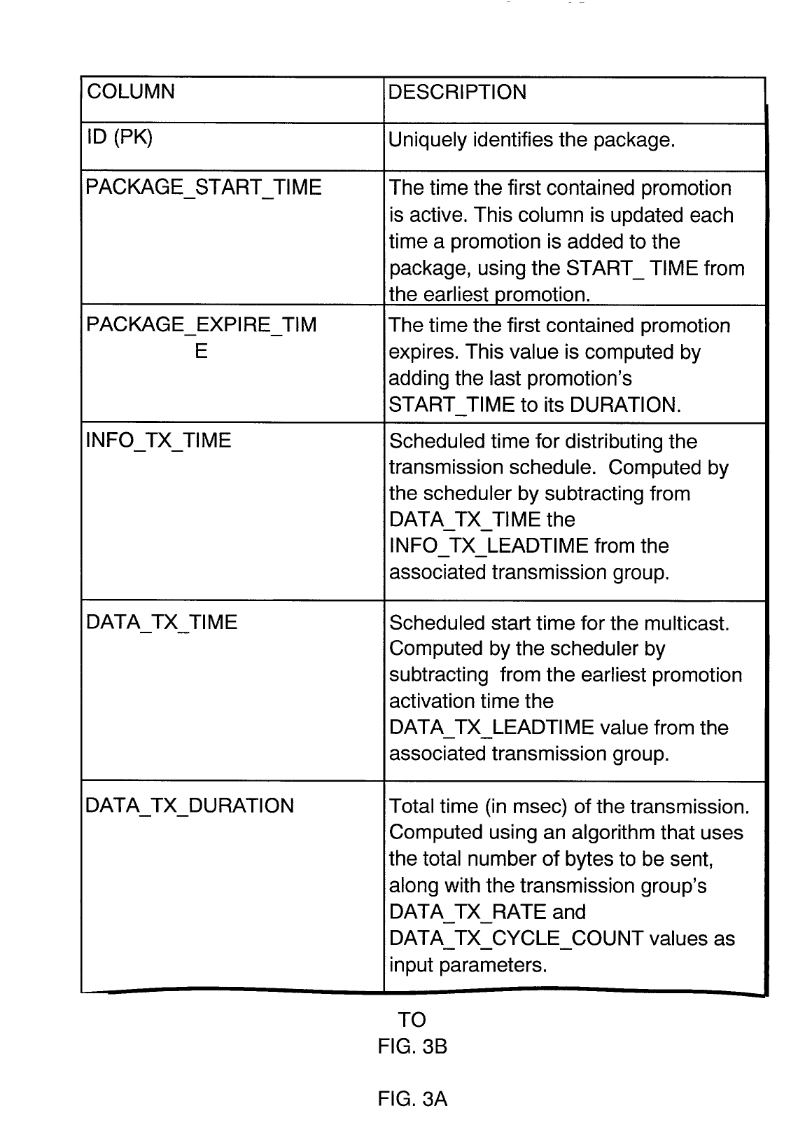

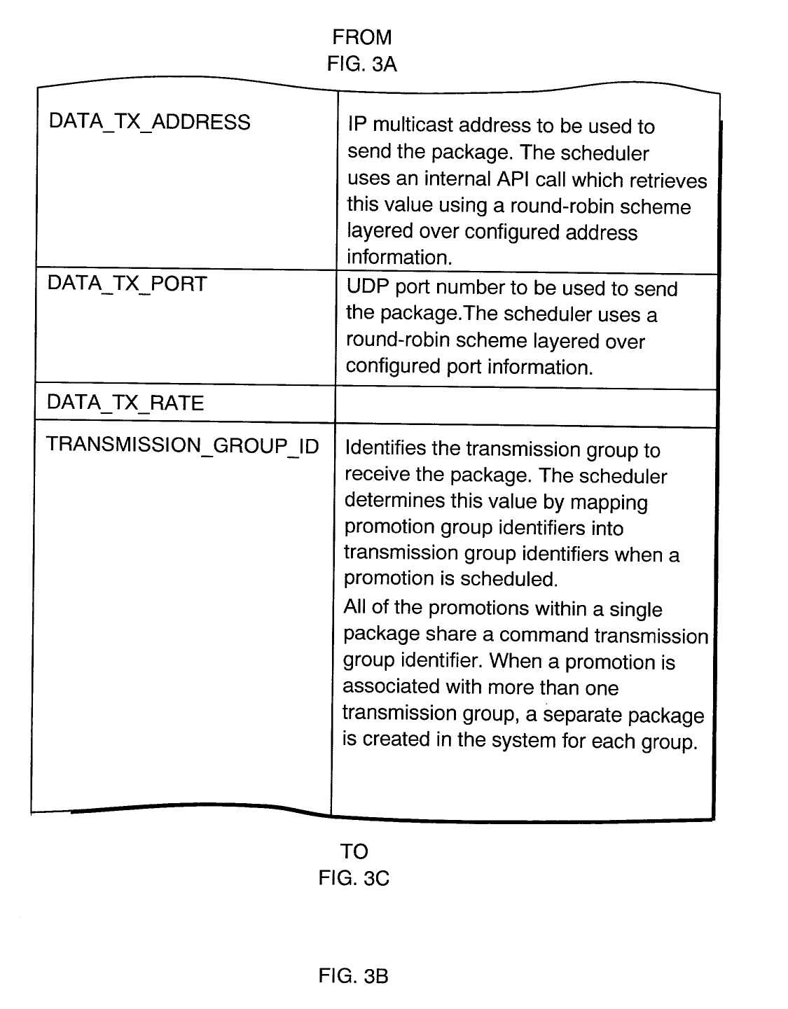

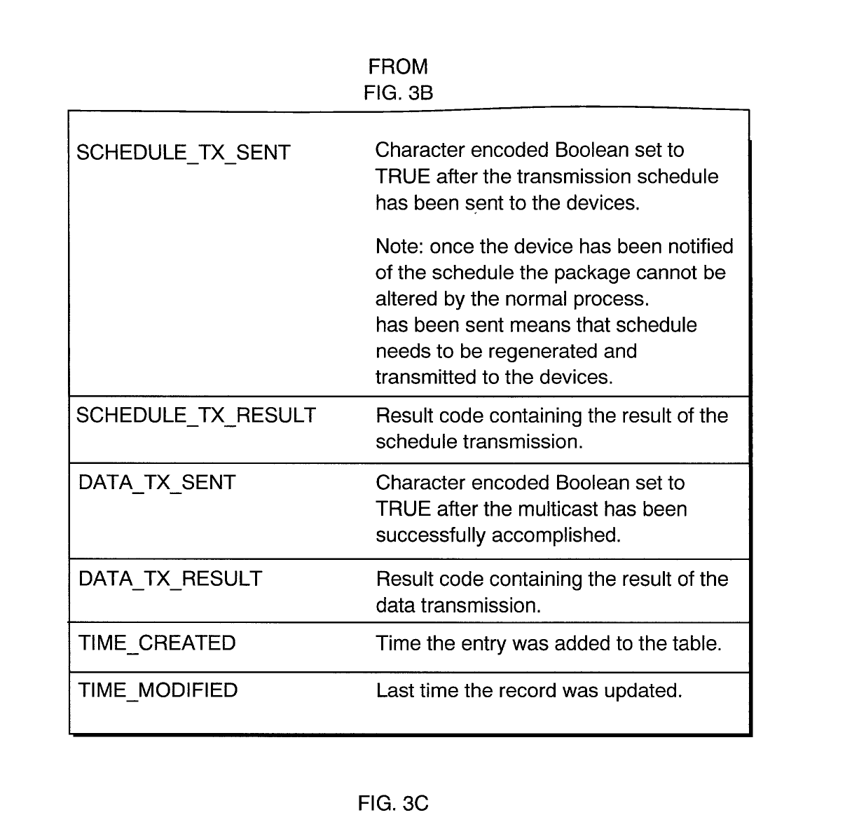

FIGS. 3A, 3B, and 3C illustrate a table stored in the database 210 which contains typical data transmission parameters specified by a package according to one embodiment. Such parameters include maximum package sizes, data rates, data transmission times, and routing addresses, such multicast or broadcast port addresses.

Relevant to the present invention, the table includes at least a DATA_TX_TIME and a DATA_TX_DURATION parameter that identify the start time of the promotion broadcast and its duration. These parameters permit a schedule process in the promotion manager 220 to determine a time at which each bulk data transmission is to begin, and its duration.

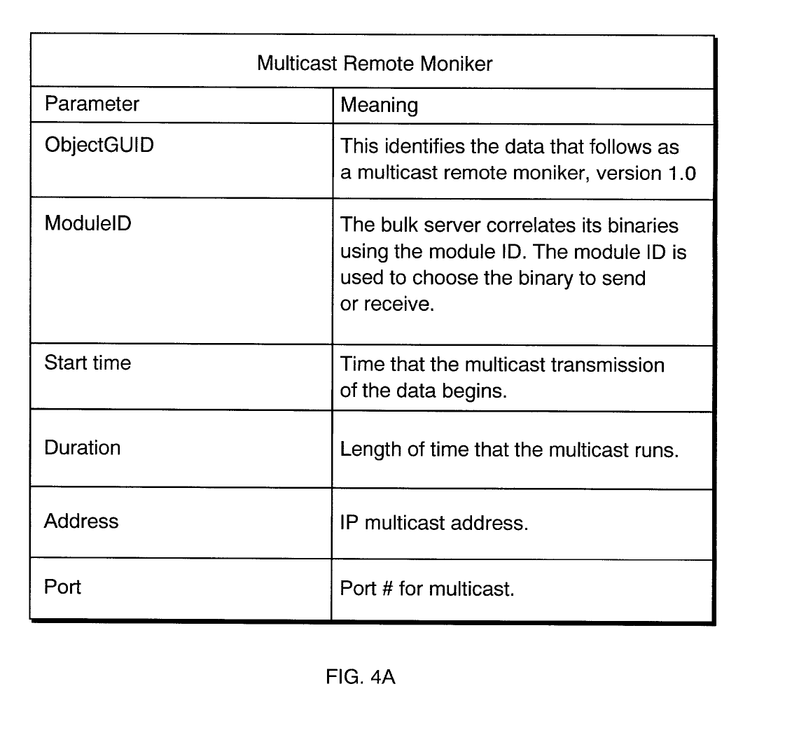

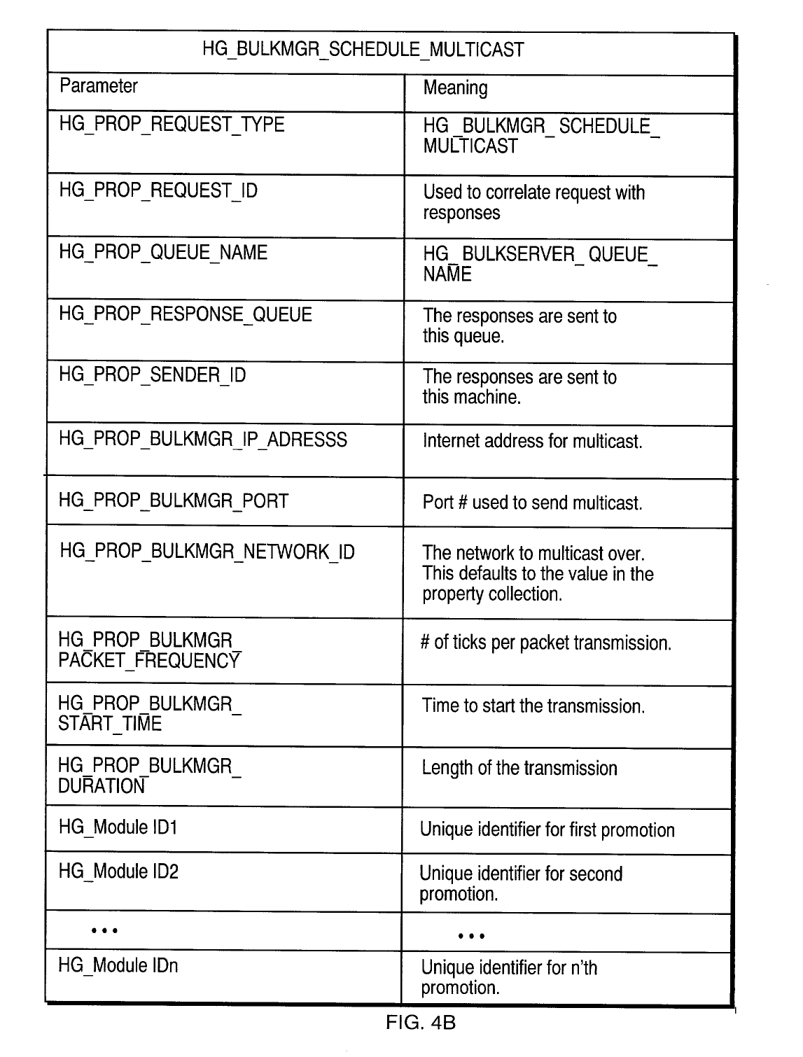

This information is then included in a schedule message which is sent out from the promotion subsystem 200 to the network devices 10 in advance of the actual promotion broadcast. One type of such schedule message is illustrated in FIG. 4A. This message contains at least a time at which the expect bulk message is to begin transmission, in the “start time” parameter”, and an expected length of transmission, in the “duration” parameter. Other fields preferably include a scheduled multicast address and port information for the bulk data multicast which is to follow. Certain other fields may include a Global Unique Identifier (GUID) identifying the message as a schedule moniker, and module identification information so that bulk data servers may correlate this schedule message with the response from the bulk data server.

FIG. 4B illustrates a database table entry used by the bulk data server 230 to coordinate the transmission scheduling of the promotion package as a multicast bulk data message.

More detail with respect to the packaging of promotion messages and generation of schedule message can be found in the co-pending U.S. Provisional Patent Application Serial No. 60/253,489 filed Nov. 28, 2000, entitled “Promotion Packaging for Transmission Groups” which is hereby incorporated by reference in its entirety.

3. Reliable Promotion Delivery Using Unreliable Transport Protocols

Once promotion packages 600 have been created, the bulk data server 230 and bulk data agent 320 provide an efficient way of delivering these packages to devices of targeted promotion groups. Due to the potential extremely large number of network devices 10, it is not efficient to deliver promotions by individually addressing each network device. Likewise, broadcast transmissions of promotions unnecessarily interrupt network devices 10 that are not targeted for the specific promotion.

Therefore, the promotion delivery system delivers promotions by preferably transmitting promotion content to all of the network devices 10 in a promotion group within a time window specific to that promotion group. A group addressing scheme such as broadcast or multicast is preferably used for these messages.

In brief overview, the process involves (1) scheduling transmissions of promotion packages for delivery to a specific promotion group; (2) notifying network devices in the promotion group of the scheduled bulk data transmission(s), including and an expected start and duration; (3) transmitting the packages of promotions via multicast or broadcast using an efficient mechanism such as UDP datagrams which do not require individual acknowledgments to be returned; (4) listening for bulk data packets during the scheduled transmissions; (5) assembling a subset of promotions indicated by a prior scheduling message; (6) at the expected end of the bulk transmission, determining if all of the expected bulk data packets have been received; (7) if not, requesting retransmission of missing packets via a unicast scheme from the bulk server.

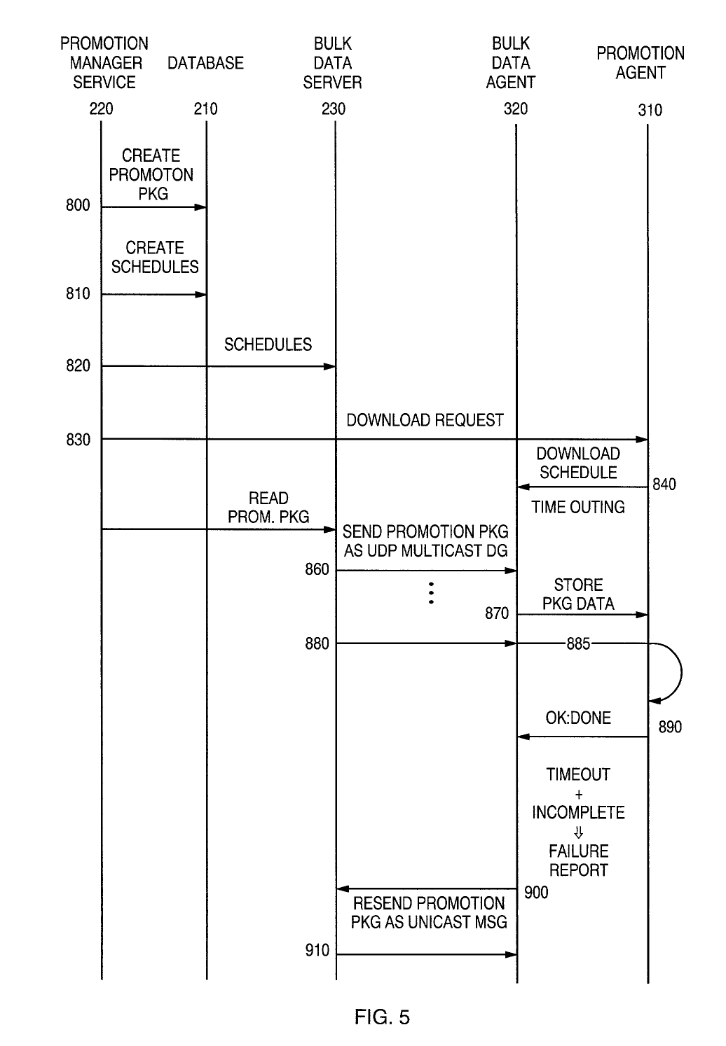

FIG. 5 is a state line diagram illustrating this process for the reliable delivery of promotions to network devices according to one embodiment of the invention. In step 800, the promotion manager server 220 creates a set of promotion packages in the promotion database 210.

In step 810, the promotion manager server 220 examines a set of promotion packages to schedule multicast transmissions of the promotions by generating transmission schedules. Each transmission schedule includes promotion control data for a specific network device targeted for one or more promotions, including at least a bulk message start time and duration. The promotion control data may also include unique promotion identifiers corresponding to promotions targeted for a device, multicast port addresses, and trigger events for initiating playback of the promotion. Such trigger events may include time of day, channel tuner events, detection of a television broadcast program, or the receipt of trigger messages.

In step 820, the promotion manager server 220 sends schedule messages to the bulk server 230, instructing the bulk server 230 to broadcast or multicast the content during a particular time window and at a particular rate.

In step 830, the promotion manager server 220 processes the transmission schedules converting them into promotion download request messages. The promotion download request messages inform the promotion agent 310 how and when to receive bulk data. The payload of this message may contain multiple property collections containing the information necessary to acquire one promotion binary from the bulk server.

In step 840, the promotion agent 310 sends individual download messages to the bulk agent 320. These inform the bulk agent of the impending bulk transmission and maintain the responsibility for selectively receiving subsets of promotions from multicast transmissions as specified. The information in this message typically includes a request ID to correlate the request with the actual response, and a time to deliver, which indicates a time by which the message should be completely delivered. The bulk agent will then use this time to determine if an attempted bulk transfer has failed, if it is not completed.

In step 850, the promotion manager server 220 has generated a transmission requests for each of the selected promotion packages, along the lines of the request of FIG. 4B. A transmission request contains promotion identifiers (i.e. HG_Module_ID) that correlate with the promotions being delivered. Furthermore, the transmission request includes the data transmission parameters from the corresponding package controlling the time and/or manner in which the set of promotions are to be transmitted. Such parameters may include data transmission rate, multicast IP address and port number, and number of transmission repeat cycles.

In step 850, the promotion manager server 220 sends the transmission requests as messages to the bulk data server 230. In an alternative embodiment, the promotion manager server 220 may send the same transmission request to multiple bulk data servers located at the head ends of the multimedia network providing additional scalability.

The bulk data server 230 then read the promotions from the database 210 indexed by their promotion identifiers specified in the transmission requests. Promotion content is transferred from the database 210 to a bulk data cache local to the bulk data server.

In step 860, the bulk data is sent using a series of broadcast or multicast datagrams.

In step 870, the bulk data agent 320 “tunes” into the multicast transmission at the specified data transmission time or in response to a specified trigger event. The bulk data agent 320 receives the transmission by subscribing to the multicast on the given multicast IP address and port. The data is received as a series of packets, with the bulk agent recording which packets are received. Each packet contains an indication of its location in the bulk data binary, since the packets may arrive in any order. At the expected end of transmission, the bulk agent can thus determine if any packets are missing.

This process continues, in state 880 and 885, with the bulk data server continuing to send the promotion package, and the network device continuing to store it. In a typical scenario, each packet may be sent more than once, e.g., repeated one or more times, to further the chance that it will be received on subsequent iterations.

The bulk data agent selectively receives the subset of promotions in the transmission and caches the promotions in its local device cache. In selectively receiving the promotions, the bulk data agent 320 scans each multicast packet for the promotion identifier corresponding to one of the subset of promotions identified in the remote monikers extracted from the promotion download request messages.

Alternatively, there are some transmission groups of devices that do not support IP multicast. For those devices, packages specify that transmission is performed through a broadcast transmission. Although broadcast transmissions of promotions would be sent to all devices, only those devices that have received transmission schedules with a time window will selectively receive the promotions from the broadcast.

In step 890, once the promotions have been successfully received by the expected transmission end time (e.g., the start time plus the duration time), they may be activated at specified times or events indicated in the transmission schedules.

However, step 900 is reached if the complete promotion package is not received as expected by the end time. In particular, this may occur if there are one or more packets of the bulk data binary which were not received. In this instance, the bulk agent 320 reports a failure to the bulk server 230. The failure report may include a specification of the particular package, or sub-portion of the package (e.g., a particular promotion) which was not correctly received.

In step 910, receipt of the failure notification causes a retransmission of the indicated missing content portion(s). The retransmission occurs using a more reliable transport mechanism, such as the Transmission Control Protocol (TCP), and using a unicast address directed to the specific failing network device 10. However, it should be understood that the bulk agent may request the bulk server to resend the entire binary via TCP (unicast), only a missing portion via TCP (unicast), or the missing portion via UDP, depending upon network design considerations and, possibly, the nature of the error.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for content push synchronization for bulk data transfer in a multimedia network, comprising:
scheduling transmission of bulk data content;
notifying a plurality of end node devices of the scheduled bulk data transmission, such notification including information indicating an expected end time for the scheduled transmission;
transmitting the bulk data content via broadcast;
attempting to selectively receive a subset of the content during the scheduled transmission;
at the expected end time for the scheduled transmission, determining if the bulk data content was received as expected; and
if not received as expected, sending a failure indication.

2. A method as in claim 1 additionally comprising:
retransmitting the bulk content to the failing network device via a unicast.

3. A method as in claim 2 wherein the failure indication indicates a subset of unreceived content and, transmitting only the indicated subset.

4. A method as in claim 1 wherein the step of transmitting the bulk content additionally comprising using a unicast UDP protocol.

5. A method as in claim 1 wherein the step of notifying the end node devices includes an expected start time and duration information.

6. A method as in claim 1 wherein the step of notifying the plurality of end node devices comprises:
delivering transmission schedules to the plurality of end node devices prior to the scheduled transmissions of bulk content.

7. A method as in claim 1 wherein the content control data comprise destination port addresses and data transmission times for the subset of content.

8. A method as in claim 4, wherein the step of selectively receiving content comprises:
listening to the scheduled transmissions for the subset of content on the destination port addresses at the data transmission times;
selecting the subset of content during the scheduled transmissions; and
receiving the subset of content.

9. A method as in claim 4 wherein the destination port addresses are multicast port addresses.

10. A method as in claim 4 wherein the destination port addresses are broadcast port addresses.

11. A method as in claim 1 wherein the content is a plurality of promotions.

12. A method as in claim 1 wherein the scheduled transmissions are scheduled multicast transmissions.

13. A method as in claim 1 wherein the scheduled transmissions are scheduled broadcast transmissions.

14. A method as in claim 1 wherein the content is transmitted multiple times during the scheduled transmissions to ensure that the plurality of end node devices receive the subset of content.

15. A method as in claim 3 wherein a failure indication is sent again if the retransmission fails.

16. A method as in claim 5 wherein a module ID is included in the failure notification.
